(19) United States
(12) Patent Application Publication
(10) Pub. No.: US 2006/0051281 A1
(43) Pub. Date: Mar. 9, 2006

(54) Metal carbides and process for producing same

(76) Inventors: Bhabendra Pradhan, Marietta, GA (US); Deepak Tandon, Kennesaw, GA (US); Rodney Taylor, Acworth, GA (US); Paul Hoffman, Dallas, GA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 10/937,043

(22) Filed: Sep. 9, 2004

(51) Int. Cl. C01B 31/30

(52) U.S. Cl. 423/439

(57) ABSTRACT

A metal carbide composition and a process for synthesizing metal carbides, through a single step process, wherein oxides of different metals, including, but not limited to Si, Ti, W, Hf, Zr, V, Cr, Ta, B, Nb, Al, Mn, Ni, Fe, Co, and Mo were physically mixed with spherical or filamentateous nano structured carbon, and inductively heated to a certain temperature range (900-1900° C.) where the metal oxide reacts with carbon to form different metal carbides. The process retains the original morphology of the starting carbon precursor in the resultant metal carbides. This method also produces highly crystalline metal nano-carbides. The metal carbide products would have applications in high temperature thermoelectric devices, quantum wells, optoelectronic devices, semi-conductors, body armour, vehicle armour, catalysts, and as discontinuous reinforced agents in metal such as aluminum and other alloys.

### CROSS-REFERENCE TO RELATED APPLICATIONS

None

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to the production of metal carbides. More particularly, the present invention relates to producing metal carbides from several carbon materials through a single step process wherein a metal oxide is combined with a carbon source and converted to the metal carbide utilizing a novel induction heating process.

2. General Background of the Invention

In the present state of the art, metal carbides are typically produced in a multiple step process in which carbon from carbon containing gases is first pyrolytically deposited onto a metal oxide. The resulting composite is subsequently reduced in an inert atmosphere by resistance heating to high temperatures of 1200° C. or greater, over a several hour period to obtain the metal carbide.

One prior art reference, included herein through the Information Disclosure Statement, teaches a single step process (J. Mat. Sci 33 (1998) 1049-1055. However, this reference also used resistance heating at extended reaction times. In these prior art procedures, the particle sizes of the metal carbide obtained are increased in comparison to those of the starting materials, and conversion is less than complete as evidenced by the presence of residual oxygen, as shown by EDS, in the resulting product.

Throughout this application the following terms shall be defined as follows:
1. “morphology” is used to describe the size and shape of carbonaceous reactants in metal carbide products.
2. “TEM”—(Transmission Electron Microscopy) is used herein to provide depictions of morphology.
3. “XRD”—(X-Ray Diffraction) is used herein to define crystal structure and phase.
4. STEMEDS, EDS—(Electron Diffraction Spectroscopy) is used herein for microscale elemental analysis.

In applicant's experimental process, applicant was expecting that the results would be a metal carbide coating over carbon core. The unexpected results obtained, as will be explained further, was a composition of wholly metal carbide products retaining the morphology of the carbon precursors.

### BRIEF SUMMARY OF THE INVENTION

In the present invention, there is provided a process for synthesizing metal carbides, through a single step process, wherein oxides of different metals, including, but not limited to Si, Ti, W, Hf, Zr, V, Cr, Ta, B, Nb, Al, Mn, Ni, Fe, Co, and Mo, were physically mixed with different, spherical (20 nm) or fibrous (60 nm) nano structured carbon precursors and inductively heated to a temperature range from 900-1900° C. where the metal oxide reacts with the carbon to form different metal carbides. The process retains the original morphology of the starting carbon precursor in the resultant metal carbides. The metal nano-carbides _produced are also highly crystalline. Most of these particles are single crystals of metal carbides. The conversion on this process is more than 80% to metal carbides, with the balance comprising unconverted excess carbon.

In yet another application, nanostructured SiC (and other carbides) would be utilized as a discontinuous reinforcement agent in aluminum and other alloys. In doing so, the nanostructured SiC would be nano-sized, spherical carbides which would minimize stress concentrations. There would also be provided branched nano-sized carbide aggregates which would be the same shape as medium or high structure carbon black aggregates, which would increase crack path tortuosity and would trap cracks.

Therefore, it is a principal object of the present invention to produce highly crystalline filamentateous nano metal carbides;

It is a further object of the present invention to produce nano metal carbides whereby the morphology of the carbon precursor in the resultant metal carbide is retained;

It is a further object of the present invention to provide a process for producing metal carbides through the use of an induction heating process;

It is a further object of the present invention to produce metal carbides completely converting MOx to metal carbides as evidenced by the absence of O in EDS and of any other phase in XRD;

It is a further object of the present invention to provide a semi-continuous or continuous process for production of metal carbides;

It is a further object of the present invention to provide a metal carbide product which can be used wherever prior art metal carbides are applied;

It is a further object of the present invention to provide metal carbides which are envisioned to replace noble metal in hydrogenation catalysts;

It is a further object of the present invention to provide nano-filament carbides with utility in specific nano-scale applications in which size requirements preclude the use of prior art metal carbides; and

It is a further object of the present invention to provide metal carbide products which would have applications in, but not limited to, high temperature thermoelectric devices, quantum wells, optoelectronic devices, semiconductors, body armour, vehicle armour, catalysts, discontinuous reinforcement agents, structural reinforcement, improving wear resistance, provide resistance to corrosion, enhance high temperature stability, provide radiation resistance, and provide increased thermal conductivity.

It is a further object of the present invention to provide metal carbide products wherein the discontinuous reinforcement agent would be present in aluminum and other alloys to minimize stress concentrations and branched nano-sized carbon aggregates would increase crack path tortuosity and would trap cracks.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 depicts the general chemistry and conditions involved in the metal carbide production in the present invention;

FIG. 2 is a schematic representation of the metal carbide production apparatus of the present invention;

FIG. 3 is a schematic representation of the metal carbide production apparatus for undertaking a semi-continuous process for producing and collecting metal carbides in the present invention;

FIG. 4 is a TEM showing the morphology of the precursor carbon black used in the process of the present invention;

FIG. 5 is a TEM of B₄C synthesized from carbon black in the present invention;

FIG. 6 is a TEM showing the morphology of the precursor carbon nanofibers used in the process of the present invention;

FIG. 7 is a TEM of molybdenum carbide produced by the process of the present invention;

FIG. 8 is a TEM of SiC crystals on the surface of SiC fiber produced in the process of the present invention;

FIG. 9 is a TEM of TiC produced in the process of the present invention;

FIG. 10 comprises XRD spectra of metal carbides derived from carbon black in the process of the present invention;

FIG. 11 comprises XRD spectra of metal carbides derived from carbon nanofibers in the process of the present invention; and

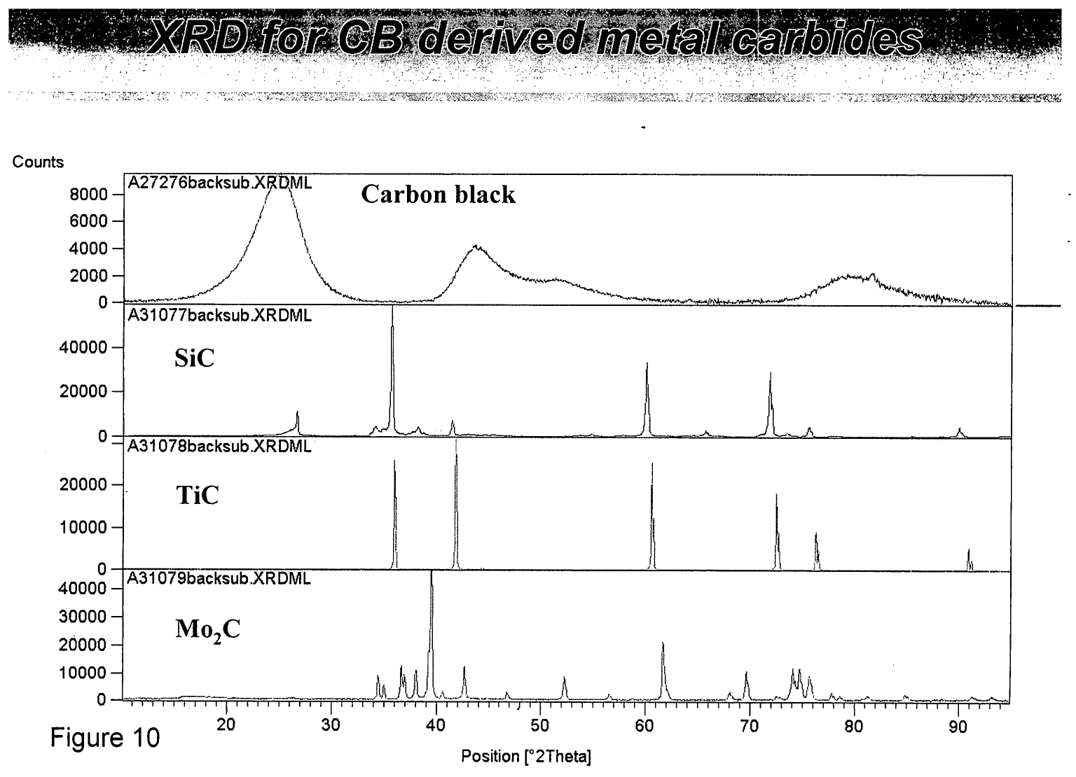

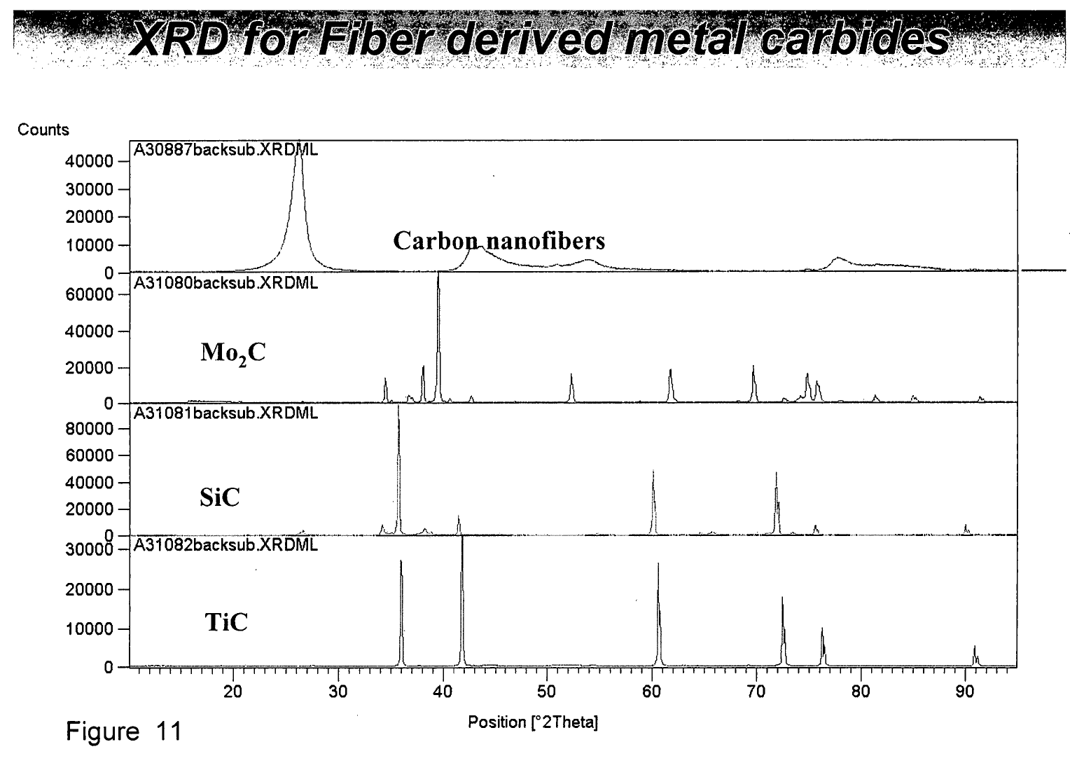

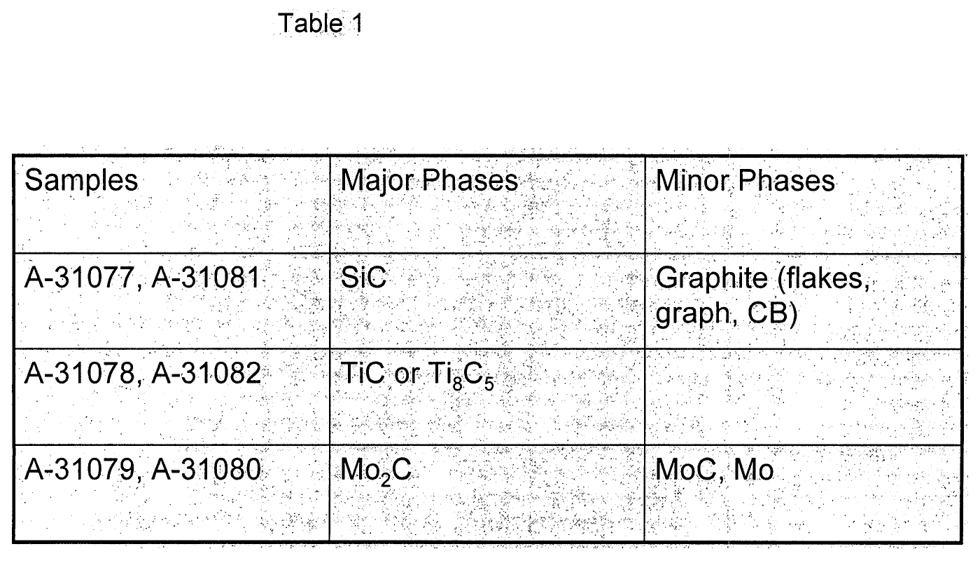

Table 1 provides the identification of major and minor phases in the XRD spectra of FIGS. 10 and 11.

### DETAILED DESCRIPTION OF THE PREFERRED EMBODIMENTS

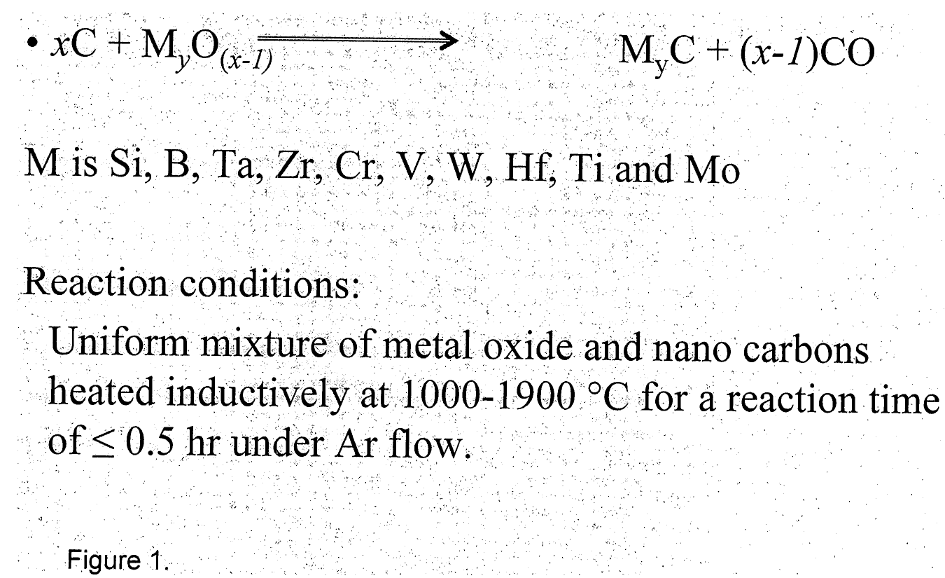

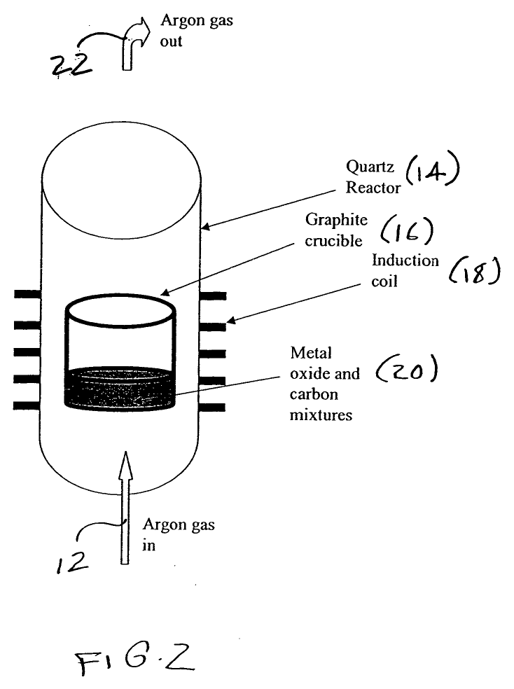

In the production of metal carbides from carbon materials through a single step process, reference is made to the FIGS. 1-11 and Table 1. As indicated earlier, overall the present invention relates to a synthesis process for producing, for example, silicon, titanium and molybdenum carbides, among others. The process comprises a single step, wherein oxides of different metals, for example Si, Ti, W, Hf, Zr, V, Cr, Ta, B, Nb, Al, Mn, Ni, Fe, Co, and Mo, are physically mixed with different spherical or filamentateous nanostructure carbons. The spherical carbon particle diameter is in the range of 8-200 nm, while the filamentateous carbon diameter is in the range of 1-200 nm. The mixture is inductively heated to a certain temperature range between 900 and 1900° C. so that the metal oxide reacts with the carbon to form different metal carbides. In the use of this process, the original morphology of the carbon precursor is maintained in the resultant metal carbides. The carbides produced are highly crystalline. The conversion of this process is more than 80% to metal carbides with the balance comprising unconverted excess carbon.

What follows are the experimental examples of combining Silicon Oxide with the nanocarbon precursor in Example 1; Titanium Oxide with the nanocarbon precursor in Example 2; Molybdenum Oxide with the nanocarbon precursor in Example 3; and Boron Oxide with the nanocarbon precursor in Example 4.

### EXPERIMENTAL EXAMPLES

### Example One

### SiO₂+3C−→SiC+2CO

Silicon carbide powders were synthesized by using 10 g of silicon dioxide and 6 g of nanocarbon as precursor. The SiO₂ powder had an average particle size of about 40 um and a specific surface area of 5 m2/g, while the carbon sources were either a carbon black (CDX975, 253 m2/g, with an average particle size 21 nm) or a filamentous nanocarbon (68.5 m2/g with an average diameter of 70 nm). Initially, both carbon source and silicon dioxide were physically mixed using either a spatula or a ball mill, until well blended. The mixture was then placed in a graphite crucible and placed inside of a quartz vessel located within an induction coil. The vessel was purged with Ar gas with a flow of 1 SLM. After 30 min of purging, the temperature of the graphite crucible was increased to 1400° C. over 30 min and held at the desired temperature for <15 min. The graphite crucible was then cooled under Ar flow. An XRD pattern of the resulting sample showed that the particles of the powder formed were hexagonal single phase silicon carbide particles. Transmission electron microscopy showed a particle size range of 20-100 nm for the product derived from CB, while the filamentous nanocarbon completely converted into Silicon carbide of morphology matching that of the precursor carbon. Thermogrametric analysis (to remove residual carbon) of the Silicon carbides produced herein showed the conversion about 95%. STEMEDS verified that the silicon carbide particles were of a very high purity.

### Example Two

### TiO₂+3C−→TiC+2CO

Titanium carbide powders were synthesized by using 13.33 g of titanium dioxide and 6 g of nanocarbon as precursor. The TiO2 powder had an average particle size of about 32 nm and a specific surface area of 45 m2/g, while the carbon sources were either a carbon black (CDX975, 253 m2/g, with an average particle size 21 nm) or a filamentous nanocarbon (68.5 m2/g with an average diameter of 70 nm). Initially, both carbon source and titanium dioxide were physically mixed using either a spatula or a ball mill, until well blended. The mixture was then placed in a graphite crucible and placed inside of a quartz vessel located within an induction coil. The vessel was purged with Ar gas with a flow of 1 SLM. After 30 min of purging, the temperature of the graphite crucible was increased to 1400° C. over 30 min and held at the desired temperature for <15 min. The graphite crucible was then cooled under Ar flow. An XRD pattern of the resulting sample showed that the particles of the powder formed were cubic single phase titanium carbide particles. Transmission electron microscopy showed an particle size range of 20-100 nm for the product derived from CB, while the filamentous nanocarbon completely converted into titanium carbide of morphology matching that of the precursor carbon. STEMEDS verified that the titanium carbide particles were of a very high purity.

### Example Three

### Mo₂O₃+4C−→MO₂C+3CO

Molybdenum carbide powders were synthesized by using 24 g of molybdenum dioxide and 6 g of nanocarbon as precursor. The Mo₂O₃ powder had an average particle size of about 20-40 nm and a specific surface area of 48 m2/g, while the carbon sources were either a carbon black (CDX975, 253 m2/g, with an average particle size 21 nm) or a filamentous nanocarbon (68.5 m2/g with an average diameter of 70 nm). Initially, both carbon source and Molybdenum oxide were physically mixed using either a spatula or a ball mill, until well blended. The mixture was then placed in a graphite crucible and placed inside of a quartz vessel located within induction coil. The vessel was purged with Ar gas with a flow of 1 SLM. After 30 min of purging, the temperature of the graphite crucible was increased to 1350° C. over 30 min and held at the desired temperature for <15 min. The graphite crucible was then cooled under Ar flow. An XRD pattern of the resulting sample showed that the particles of the powder formed were hexagonal single phase Molybdenum carbide particles. Transmission electron microscopy showed an particle size range of 20-100 nm for the product derived from CB, while the filamentous nanocarbon completely converted into Molybdenum carbide of morphology matching that of the precursor carbon. STEMEDS verified that the Molybdenum carbide particles were of a very high purity.

### Example Four

### 2B₂O₃+7C−→B₄C+6CO

Boron carbide powders were synthesized by using 14 G of boron oxide and 8.4 g of nanocarbon as precursor. The B₂O₃ powder had an average particle size of about 40 um and a specific surface area of 5 m2/g, while the carbon sources were either a carbon black (CDX975, 253 m2/g, with an average particle size 21 nm) or a filamentous nanocarbon (68.5 m2/g, with an average diameter of 70 nm). Initially, both carbon source and Boron oxide were physically mixed using either a spatula or a ball mill, until well blended. The mixture was then placed in a graphite crucible and placed inside of a quartz vessel located within induction coil. The vessel was purged with Ar gas with a flow of 1SLM. After 30 min of purging, the temperature of the graphite crucible was increased to 1300° C. over 30 min and held at the desired temperature for <15 min. The graphite crucible was cooled under Ar flow. An XRD pattern of the resulting sample showed that the particles of the powder formed were hexagonal single phase boron carbide particles. Transmission electron microscopy showed an particle size range of 20-100 nm for the product derived from CB, while the filamentous nanocarbon completely converted into boron carbides of morphology matching that of the precursor carbon.

Turning now to the FIGS. 1 through 11 and Table 1: FIG. 1, depicts the chemistry and reaction conditions associated with the present invention: xC+M_{y}O₍ₓ₋₁₎→M_{y}C+(x-1)CO, wherein M is selected from a group including, but not limited to, Si, B, Ta, Zr, Cr, V, W, Hf, Ti and Mo. The reaction requires that a uniform mixture of metal oxide and nanocarbons be heated inductively at 900° to 1900° C. and held thereat for 1-30 min. under inert gas flow.

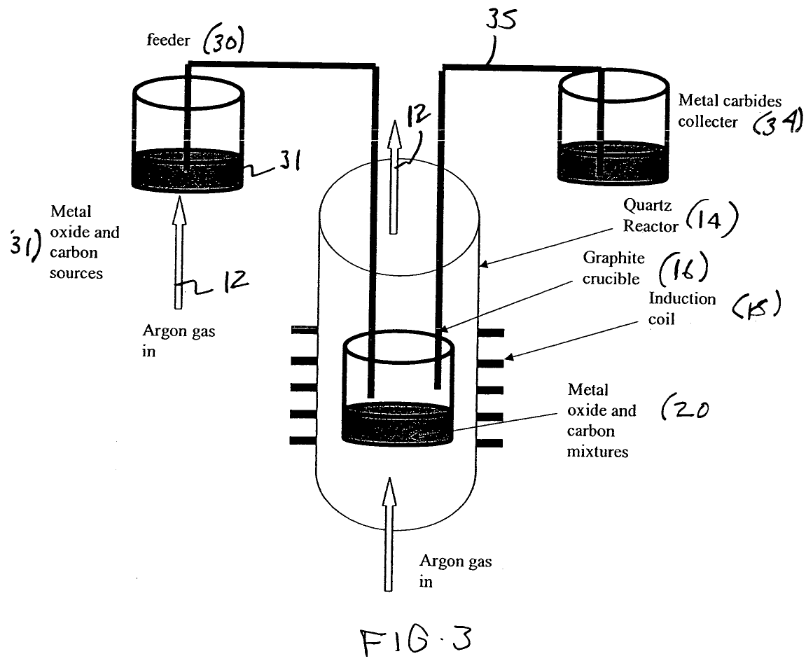

Batch and semicontinuous means for producing the metal carbides, set forth in FIG. 1, are depicted schematically in FIGS. 2 and 3 respectively. The apparatus depicted in FIG. 2 was employed in the Examples 1 through 4.

FIG. 2 provides a schematic representation for the metal carbide experimental process as practised in a batch mode. In FIG. 2 there is illustrated argon gas (arrow 12) that enters into a quartz reactor 14, of the type commonly known in the industry, which contains a graphite crucible 16, surrounded by an induction coil 18. A mixture of Metal oxide and carbon is placed within the graphite crucible 16 at 20. The mixture is then heated via the induction coil 18 to a temperature between 900 and 1900° C. The argon gas is vented out (arrow 22) and the resultant metal carbide remains in the crucible 16 for collection.

FIG. 3 provides a schematic representation of the semi-continuous or continuous production of metal carbides. As depicted, metal carbide powders can be synthesized semi-continuously by using a quartz reactor 14. The quartz reactor 14 includes a graphite crucible 16 which would contain the metal oxide and carbon mixtures at 20. There would also be included the induction coil 18, surrounding the quartz reactor, for heating the mixture as described in FIG. 2. However, in the semi-continuous process illustrated in FIG. 3, there is provided a feeder 30 which contains the premixed metal oxide and carbon precursors at 31. The argon gas (arrow 12) is introduced into the mixture of the metal oxide and carbon sources at 31 in feeder 30, and the mixture is pneumatically conveyed thereby into graphite crucible 16, where the mixture is heated by the induction coil 18 to the desired temperature of 900 to 1900° C. and held thereat for 1-30 min. There is provided a collector 34, to which the resultant metal carbides can be conveyed from the crucible 16, via vacuum line 35, for collection. The quartz reactor is purged with argon gas 12 with a flow of 1 SLM. This process can be repeated to achieve semi-continuous production of metal carbides without opening the reactor system.

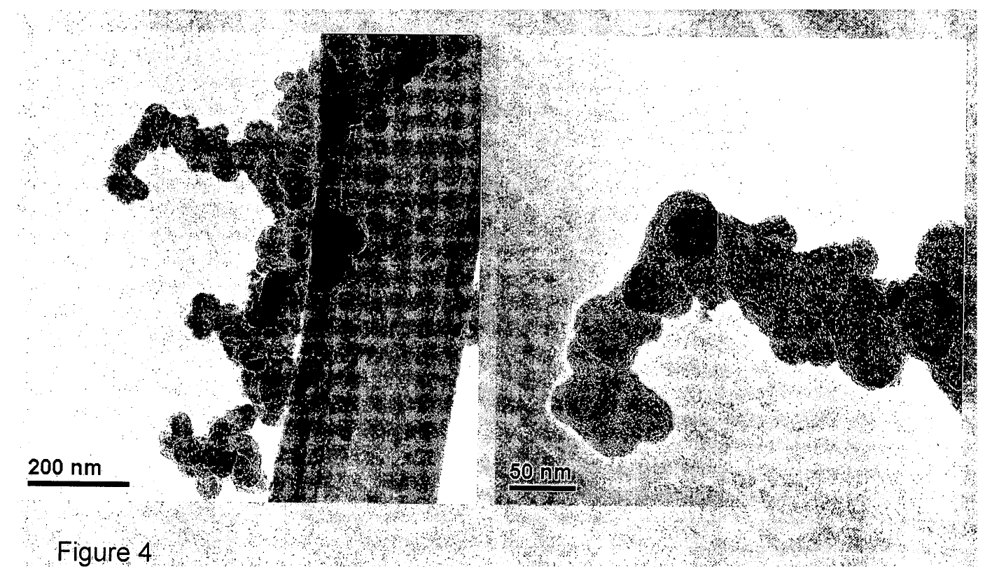

FIGS. 4 through 9 are transmission electron micrographs which depict the morphologies of the carbon reactants (4,6) and carbide products (5,7-9) representative of those used and produced in examples 1-4 preceding.

FIG. 4 is a TEM depicting the morphology of the nanocarbon black that is used as the precursor in the described experiment. This carbon black is CDX-975 (Columbian Chemicals Co.) With an average particle size of 21 nm.

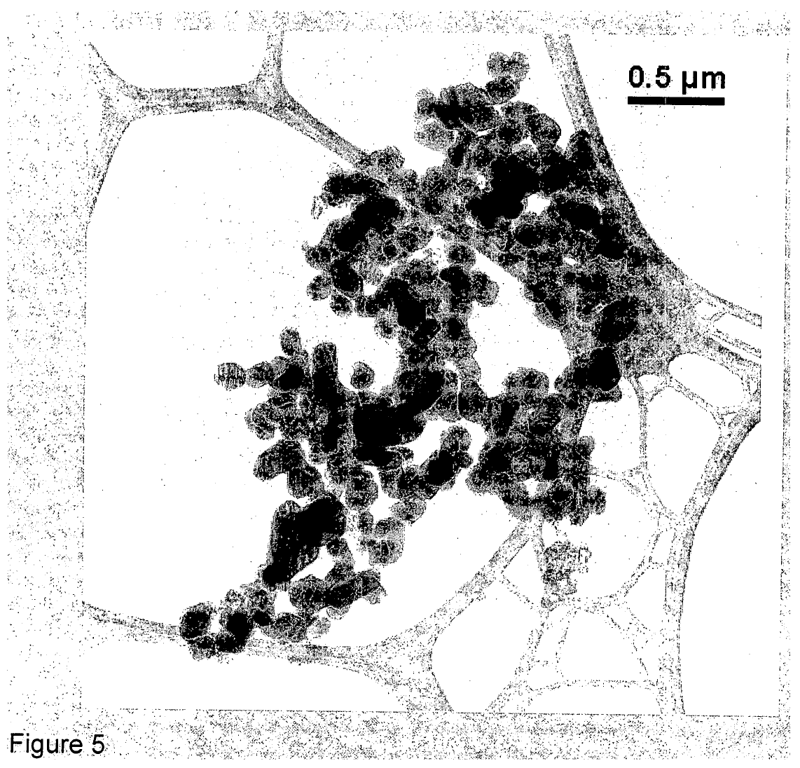

FIG. 5 is a TEM depicting the Boron Carbide (B₄C) produced as described in Example 4 from the carbon black depicted in FIG. 4.

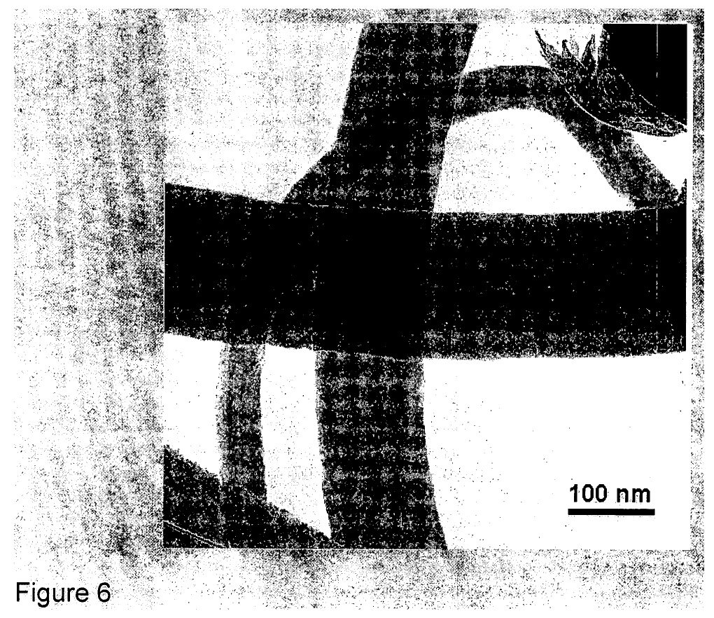

FIG. 6 is a TEM depicting the carbon nanofiber precursor as used in experiments 1-4. This material has a nitrogen surface area of 68 m²/g and an average fiber diameter of 70 nm.

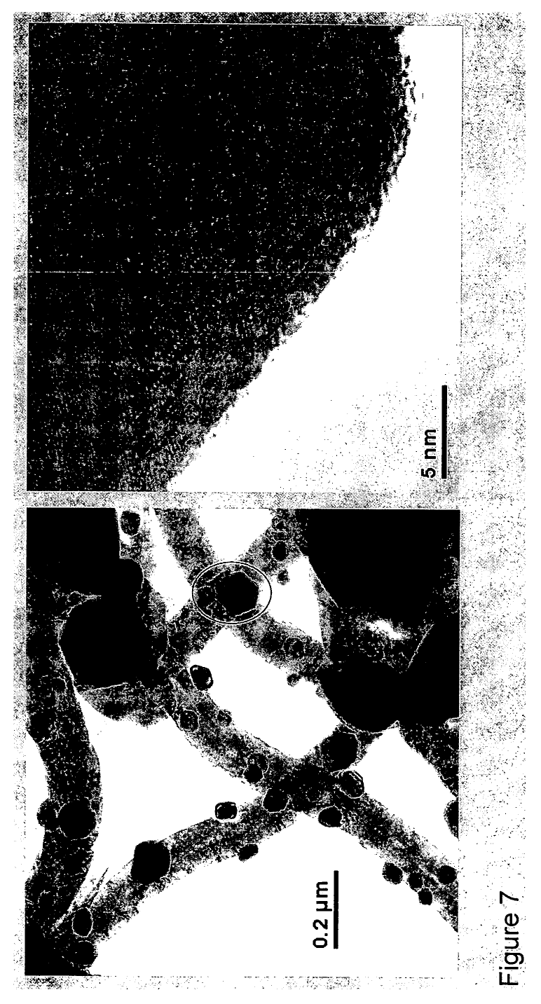

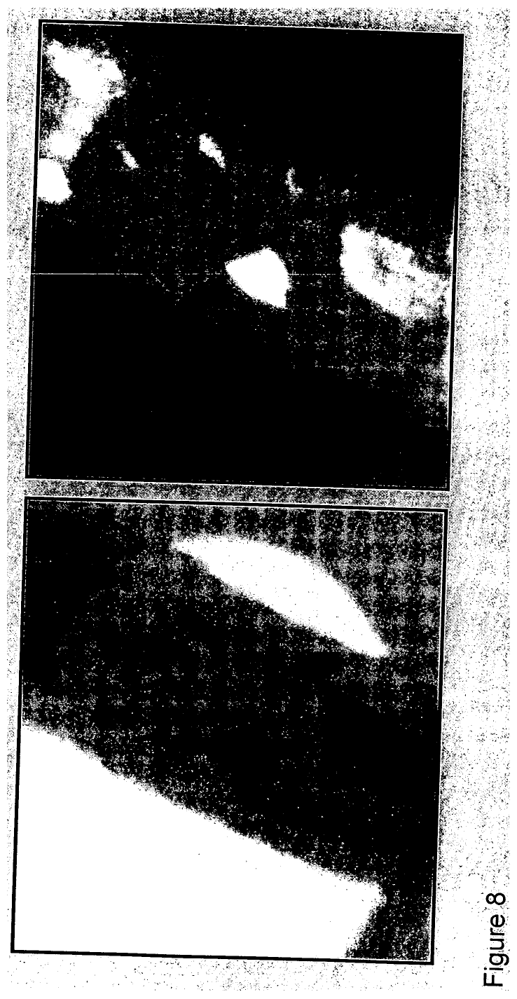

FIG. 7 is a TEM of molybdenum carbide fibers produced as described in example 3 from the carbon nanofiber depicted in FIG. 6. Note the presence of Mo₂C crystallites adhered to the fiber surface.

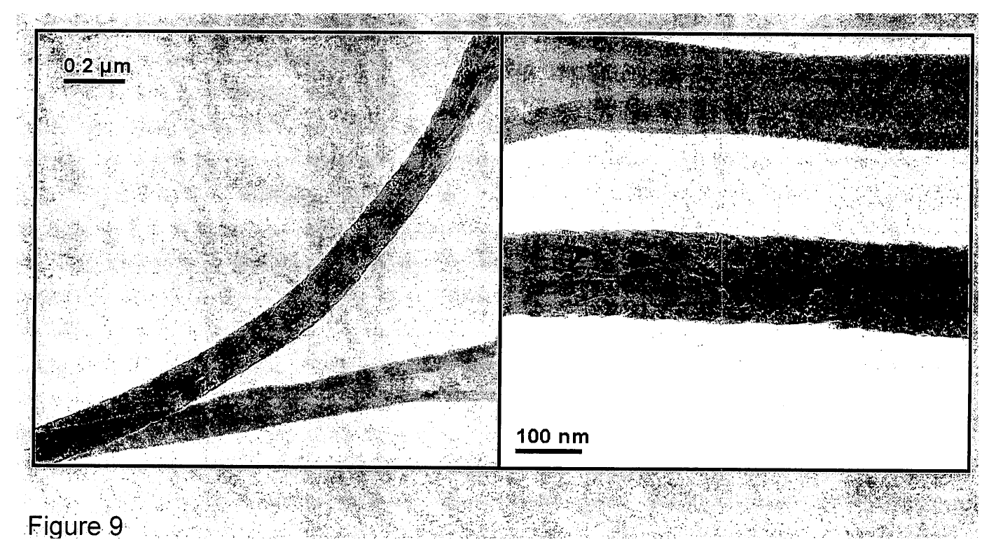

FIG. 8 depicts a TEM of SiC fibers produced as described in example 1 from the carbon nanofiber depicted in FIG. 6. STEM/EDAX analysis showed no residual oxygen to be present in this product, indicating complete conversion to the carbide.

FIG. 9 is a TEM of TiC fibers produced as described in Example 2 from the carbon nanofiber depicted in FIG. 6. STEM/EDAX analysis showed no residual oxygen to be present, in this product, indicating complete conversion to the carbide.

Turning now to Table 1, entitled “Identification of Major and Minor Phases of XRD Spectra,” XRD analysis was also carried out on the samples from experiments 1-4. The three samples (A-31077, A-31078, and A-31079) were different metal carbides derived from carbon black (CDX975, A027276), while samples A-31080, A-31081 and A-31082 were similar metal carbides derived from carbon nanofibers (sample A-30887). XRD spectra from the metal carbides derived from CB are shown in FIG. 10, while the spectra from those derived from fibers are shown in FIG. 11. Matching of peaks reveals no difference in the carbide phases produced from the two starting materials. A listing of major and minor component peaks in the XRD spectra is given in Table 1. These results demonstrate the essentially complete conversion of the starting materials to their respective carbides.

The foregoing embodiments are presented by way of example only; the scope of the present invention is to be limited only by the following claims.

What is claimed as invention is:

1. A metal carbide composition resulting from the reaction of a metal oxide and a nano-carbon precursor.

2. The composition in claim 1, wherein the metal oxide is selected from a group of metal oxides of Si, Ti, W, Hf, Zr, Cr, Ta, B, V, Nb, Al, Mn, Ni, Fe, Co, and Mo.

3. The composition in claim 1, wherein the nano-carbon comprises spherical or fibrous nano structured carbon.

4. The composition in claim 3, wherein the spherical carbon particle diameter is in the range of 8-200 nm.

5. The composition in claim 3, wherein the filamentateous carbon diameter is in the range of 1-200 nm.

6. The composition in claim 1, wherein the metal oxide and nano-carbon precursor are inductively heated to a temperature range between 900 and 1900° C.

7. The composition in claim 6, wherein the heating of the metal oxide and nano-carbon precursor is achieved in an induction furnace.

8. A metal carbide composition resulting from the reaction of a metal oxide and a filamentateous or spherical nano-carbon precursor in an induction furnace at a temperature of between 900 and 1900° C.

9. The composition in claim 8, wherein the resulting metal carbide is a highly crystalline filamentateous nano metal carbide.

10. The composition in claim 8, wherein the resulting conversion to metal carbide is substantially complete.

11. The composition in claim 8, wherein the nano metal carbide maintains substantially the size and morphology of the carbon precursor.

12. The composition in claim 8, wherein the metal oxide is selected from a group of metal oxides including Si, Ti, W, Hf, Zr, Cr, Ta, B, V, Nb, Al, Mn, Ni, Fe, Co, and Mo.

13. A process of producing metal carbides through the steps of combining a metal oxide with a carbon precursor, heating the combination in an induction furnace so that the resulting metal oxide is completely converted from MOx without any residual oxygen.

14. The process in claim 13, wherein the metal oxide and nano-carbon precursor are inductively heated to a temperature range between 900 and 1900° C.

15. The process in claim 13, wherein the process is a continuous process.

16. A process for producing metal carbides, comprising the following steps:
a. providing a metal oxide;
b. mixing the metal oxide with a nano-carbon precursor;
c. heating the mixture in an induction furnace to a temperature of between 900 and 1900 degrees C.
d. introducing inert gas into the mixture during heating;
e. collecting the resultant metal carbide at the end of the heating cycle;
f. repeating steps a through e as a continuous process.

17. A process for producing metal carbides, comprising the following steps:
a. providing a metal oxide;
b. mixing the metal oxide with a nano-carbon precursor;
c. heating the mixture in an induction furnace added to a temperature between 900-1900° C. for a period of <30 min.
d. introducing inert gas into the mixture during heating;
e. collecting the resultant metal carbide at the end of the heating cycle;
f. repeating steps a through e as a continuous process.

18. The process in claim 17, wherein the resulting metal carbide is applied in high temperature thermoelectric devices.

19. The process in claim 17, wherein the resulting metal carbide is applied in quantum wells.

20. The process in claim 17, wherein the resulting metal carbide is applied in optoelectronic devices.

21. The process in claim 17, wherein the resulting metal carbide is applied in semi-conductors.

22. The process in claim 17, wherein the resulting metal carbide is applied in armour.

23. The process in claim 17, wherein the resulting metal carbide is applied in catalysts.

24. The process in claim 23, wherein the application in catalyst comprises hydrogenation, dehydrogenation, reforming, denitrogenation and desulferization

25. The process in claim 17, wherein the resulting metal carbide is applied in discontinuous reinforcement agents.

26. The process in claim 17, wherein the resulting metal carbide is applied in structural reinforcement.

27. The process in claim 17, wherein the resulting metal carbide is applied to improve wear resistance.

28. The process in claim 17, wherein the resulting metal carbide is applied to provide resistance to corrosion.

29. The process in claim 17, wherein the resulting metal carbide is applied to enhance high temperature stability.

30. The process in claim 17, wherein the resulting metal carbide is applied to provide radiation resistance.

31. The process in claim 17, wherein the resulting metal carbide is applied to provide increased thermal conductivity.
